(19) United States
(12) Patent Application Publication
(10) Pub. No.: US 2012/0054522 A1
(43) Pub. Date: Mar. 1, 2012

(54) ELECTRONIC DEVICE WITH SLEEP MODE AND METHOD FOR AWAKING ELECTRONIC DEVICE

(75) Inventors: YAN-XIANG HUANG, Shenzhen City (CN); SHA-SHA HU, Shenzhen City (CN); YU-LIANG YANG, Shenzhen City (CN); HSIEN-CHUNG SHIH, Tu-Cheng (TW); BO-CHING LIN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/095,870

(22) Filed: Apr. 28, 2011

(30) Foreign Application Priority Data
Aug. 24, 2010 (CN) 201010261456.5

(51) Int. Cl. G06F 1/32

(52) U.S. Cl. 713/323

(57) ABSTRACT

An electronic device with a sleep mode includes a CPU and a monitoring unit. The monitoring unit includes a testing module, a storage module, a comparing module, and a signal generating module. The CPU falls into standby mode when the electronic device is in the sleep mode. When the comparing module determines any one of one or more parameters of a battery which supplies power to the electronic device measured by the testing module is not within a corresponding predetermined range stored in the storage module, the signal generating module generates signals to awake the CPU. The awaked CPU executes protection operation to protect the electronic device. A related method is also provided.

### BACKGROUND

1. Technical Field

The present disclosure relates to electronic devices, and particularly, to an electronic device which can enter a sleep mode and a method for awaking the electronic device from the sleep mode.

2. Description of the Related Art

Many electronic devices include a normal mode and a sleep mode. In the normal mode, a CPU of an electronic device can track status of a battery of the electronic device, such as charge state and temperature of the battery. If there is anything wrong with the battery or the charge is too low, the CPU can take steps such as turning off the electronic device or switching to an alternate power supply. However, when the electronic device is in the sleep mode, the CPU does not track status of the battery.

Therefore, there is room for improvement within the art.

### BRIEF DESCRIPTION OF THE DRAWINGS

The components in the drawings are not necessarily drawn to scale, the emphasis instead being placed upon clearly illustrating the principles of an electronic device with sleep mode and a method for awaking the electronic device. Moreover, in the drawings, like reference numerals designate corresponding parts throughout the several views.

FIG. 1 is a block diagram of an electronic device in accordance with an exemplary embodiment.

FIG. 2 is a flowchart of a method for awaking an electronic device in accordance with an exemplary embodiment.

### DETAILED DESCRIPTION

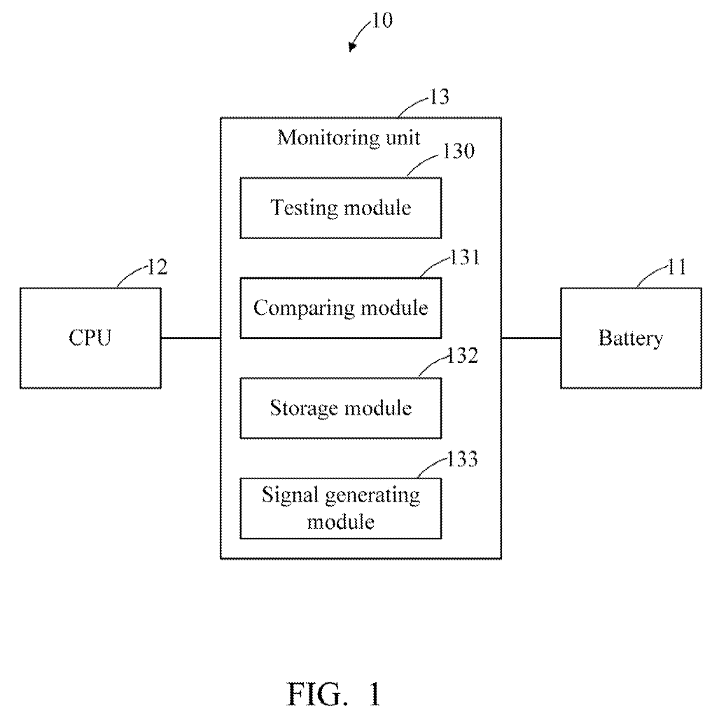

Referring to FIG. 1, an electronic device 10 includes a battery 11, a CPU 12, and a monitoring unit 13. The battery 11 is configured for supplying power to the electronic device 10. When the electronic device 10 is in a sleep mode, the CPU 12 falls into a standby mode, and the monitoring unit 13 is enabled to track status of the battery 11. When the monitoring unit 13 determines there is problem with the battery, the monitoring unit 13 awakes the CPU 12, and signals the CPU 12 to turn off the electronic device 10 or cut off the electrical connection between the battery 11 and electronic elements of the electronic device 10 to protect the electronic device 10.

The monitoring unit 13 includes a testing module 130, a comparing module 131, a storage module 132, and a signal generating module 133.

The testing module 130 is configured to measure one or more parameters of the battery 11. In the embodiment, the one or more parameters may include at least one selected from the group consisting of temperature, output voltage, and output current. Accordingly, the testing module 130 may include a temperature sensor, a voltage sensor, and/or a current sensor, corresponding to more than one of the one or more parameters to be measured.

The storage module 132 is configured for storing one or more predetermined ranges corresponding to the one or more parameters of the battery 11. The comparing module 131 is configured for determining whether the measured one or more parameters are within a predetermined range stored in the storage module 132. The one or more predetermined ranges may include a temperature range, a voltage range, and a current range.

The signal generating module 133 is configured for generating signals to awake the CPU 12 when any one of the measured one or more parameters is not within the corresponding predetermined range. After the CPU 12 is awaked, the CPU 12 executes protection operation to protect the electronic device 10. In the embodiment, after the CPU 12 is awaked, the CPU 12 compares a current voltage of the battery 11 measured by the testing module 130 with a predetermined reference voltage, the predetermined reference voltage represents a minimum voltage level needed to power the electronic device 10 in the normal mode. The CPU 12 turns off the electronic device 10 if the current voltage of the battery 11 is lower than the predetermined reference voltage.

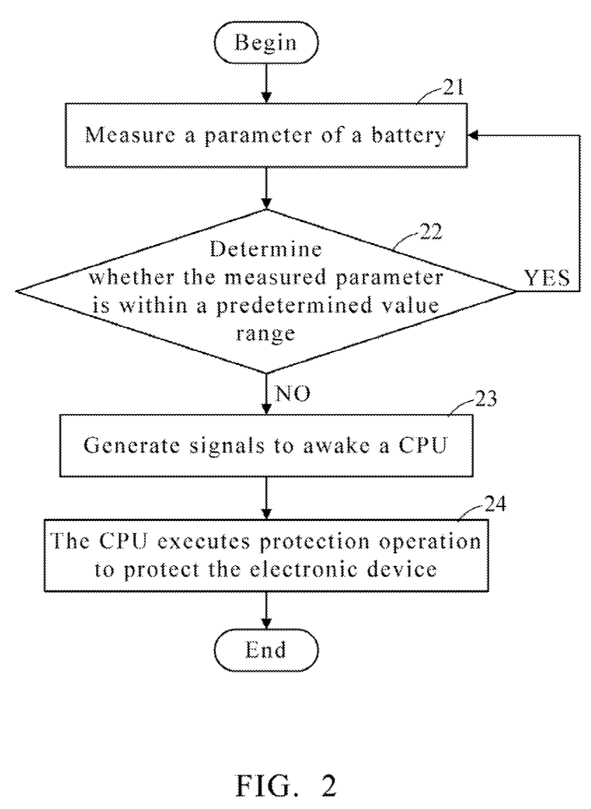

FIG. 2 is a flowchart of a method for awaking the electronic device 10 in accordance with an exemplary embodiment.

In step S21, the testing module 130 measures a parameter of the battery 11.

In step S22, the comparing module 221 determines whether the measured parameter of the battery 11 is within a predetermined range stored in the storage module 132. If no, the procedure goes to step S23, otherwise, the procedure returns to step S21.

In step S23, the signal generating module 133 generates signals to awake the CPU 12.

In step S24, the CPU 12 executes protection operation to protect the electronic device 10.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device, comprising:
a CPU to fall into a standby mode when the electronic device is in a sleep mode;
a monitoring unit, comprising:
a testing module configured for measuring one or more parameters of a battery which supplies power to the electronic device;
a storage module configured for storing one or more predetermined ranges corresponding to the one or more parameters of the battery;
a comparing module configured for determining whether the measured one or more parameters are within the predetermined range; and
a signal generating module configured for generating signals to awake the CPU when any one of the measured one or more parameters is not within the corresponding predetermined range;
wherein the CPU executes protection operation to protect the electronic device after the CPU is awaked.

2. The electronic device as recited in claim 1, wherein the one or more parameters of the battery comprise at least one selected from the group consisting of temperature, output voltage, and output current.

3. The electronic device as recited in claim 2, wherein the testing module comprises a temperature sensor, a voltage sensor, and a current sensor, corresponding to more than one of the one or more parameters to be measured.

4. The electronic device as recited in claim 3, wherein the one or more predetermined ranges comprise a temperature range, a voltage range, and a current range.

5. A method for awaking an electronic device with a sleep mode, the electronic device comprising a CPU, the method comprising:
measuring a parameter of a battery which supplies power to the electronic device;
determining whether the measured parameter of the battery is within a predetermined range;
generating signals to awake the CPU when the measured parameter is not within the corresponding predetermined range and the CPU is in standby mode; and
executing protection operation to protect the electronic device via the CPU.

6. The method as recited in claim 5, wherein one or more parameters of the battery comprise at least one selected from the group consisting of temperature, output voltage, and output current.

7. The method as recited in claim 6, wherein the testing module comprises a temperature sensor, a voltage sensor, and a current sensor, corresponding to more than one of the one or more parameters to be measured.

8. The method as recited in claim 7, wherein the one or more predetermined ranges comprise a temperature range, a voltage range, and a current range.
